(19) United States
(12) Patent Application Publication
(10) Pub. No.: US 2007/0126830 A1
(43) Pub. Date: Jun. 7, 2007

(54) Combined Conventional And Sublimation Lithographic Ink System

(76) Inventor: Joseph F. Torquato, Scranton, PA (US)

Correspondence Address: MITCHELL A. SMOLOW, 720 HAMPTON ROAD, SHAVERTOWN, PA, 18708, US

(21) Appl. No.: 11/164,829

(22) Filed: Dec. 7, 2005

(51) Int. Cl. G01D 11/00

(52) U.S. Cl. 347/100

(57) ABSTRACT

The invention relates to an offset lithographic ink system containing a combination of conventional and sublimation colorants used to generate a first substrate printing with commercially acceptable quality color characteristics, notably, but not limited to, life-like flesh tones, which can also serve as an intermediate transfer medium. The first substrate may then, using known heat activation techniques, transfer the image printed on the first substrate to a second substrate yielding a printing of commercially acceptable quality color characteristics, notably, but not limited to, life-like flesh tones.

### FIELD OF THE INVENTION

This invention relates generally to inks used in commercial printing and in particular, to combined conventional and sublimation ink system for use in the offset lithographic printing process.

### BACKGROUND OF THE INVENTION

Printing processes are distinguished by the type of image carrier (often referred to as plates) utilized and the method of image transfer. Images may be transferred to a substrate either directly, as in the gravure, flexography, screen printing and letterpress printing processes, or they may be transferred indirectly, as in the offset printing process.

Lithography, photolithography, offset, litho-offset and offset lithography are terms used interchangeably in commercial printing for the most widely used form of planographic printing. Planographic printing is a method of image transfer in which the image carriers (or plates) have the image and non-image areas in the same plane. The image areas are neither raised nor indented in relation to the non-image areas. Differing physiochemical properties distinguish the image and non-image areas.

Lithographic plates undergo a chemical process to make the image area of the plate oleophilic and the non-image area hydrophilic. The oleophilic (image) areas are ink-receptive while the hydrophilic (non-image) areas are not.

In offset printing, ink is not applied directly from the printing plate to the substrate, but rather, ink is applied to the printing plate (often in the form of a cylinder) to form the image and then transferred or “offset” to a rubber covered cylinder or “blanket”. The image on the blanket is subsequently transferred to the substrate, typically paper or paperboard carried by an impression cylinder, thereby producing the printed product.

This use of cylinders allows offset and other forms of planographic printing to make possible increased production speeds, improved quality in the reproduction of fine tones, and a substantial reduction in the number of impressions required to reproduce full color copy. Sheet fed presses feed the substrate into the press one sheet at a time at very high speeds, while web fed presses print on a continuous roll of substrate (the “web”), which is later cut to size.

During printing, a thin layer of fountain (dampening) solution is first applied to the printing plate. This fountain solution consists primarily of water with small quantities of additives to lower surface tension and control pH migrates to the hydrophilic non-image areas of the printing plate. After application of the fountain, ink is applied to the plate, migrating to the oleophilic image areas. The fountain solution prevents ink from migrating to the non-image areas of the plate because the ink and water do not mix.

In practice, as the image plate cylinder rotates, the plate first comes into contact with the dampening rollers which wet the plate so that the non-printing plate areas repel ink. Subsequently, the inking rollers transfer ink to the dampened plate, where ink only adheres to the image areas due to the previously applied dampening solution. Finally, the inked image is transferred to the rubber blanket which prints the substrate as the substrate passes between the blanket and an impression cylinder.

There are four common types of Lithographic inks: petroleum based, vegetable oil based, Ultraviolet (UV) and Electron Beam (EB) curable, and heat set. Lithographic inks are very viscous, often paste-like, and are generally very strong in color value to compensate for the lesser amount applied. The inks also contain solvents or drying oils to accelerate drying and control ink flow.

A subset of lithographic inks utilize sublimation dyes. Sublimation inks are generally utilized where the printed substrate is an intermediate medium, such as paper, often referred to as a transfer sheet, which is thereafter used in a separate process, often referred to as transfer printing. The transfer printing process is generally removed in time and distance from the offset printing process of the intermediate medium. During the transfer printing process, heat and pressure are applied to the backside of the transfer sheet while the transfer sheet is in contact with a final substrate. The dyes vaporize and are preferentially absorbed by the final substrate, most often woven textiles of natural and synthetic fibers, followed by separation of the transfer sheet and the final substrate.

The sublimation dyes achieve their useful, desired color quality, i.e. tone, clarity, and depth of the coloring, as a result of the transfer printing process. Prior to the transfer printing process, the intermediate substrate has unacceptable color quality for use in commercial settings, and that is why sublimation inks are not used in non-transfer printing applications. Non-sublimation inks (for purposes of this application referred to as conventional inks) are instead used in non-transfer printing process applications.

However, in recent times, commercial applications have arisen where simultaneous use of both conventional and sublimation inks are desirable. For example, as a sales inducement, manufactures who market their products to children and teenagers want the ability to use their product packaging as a transfer sheet. Until recently, such product packaging required two printing runs, a first to apply conventional inks to highlight the product and a second run to apply sublimation inks. Because the color qualities of sublimation inks prior to the transfer printing process are poor, the overall esthetics of the product packing were likewise poor.

Recent attempts to combine conventional and sublimation inks for use in a single print run have yielded less than ideal results. Notably, colors used to produce skin tones have remained non-life-like and generally unacceptable for quality product packaging.

Accordingly, there remains a continuing need for improved formulations of combined conventional and sublimation inks for use in offset lithographic printing. The present invention fulfills this need and further provides related advantages.

### BRIEF SUMMARY OF THE INVENTION

The invention relates to an offset lithographic ink system containing a combination of conventional and sublimation colorants used to generate a single pass printing with commercially acceptable quality color characteristics, notably, but not limited to, life-like flesh tones, which can also serve as an intermediate transfer medium. The medium, hereinafter referred to as the first substrate, may then, using known heat activation techniques, transfer the image printed on the first substrate to a second substrate yielding a printing of commercially acceptable quality color characteristics, notably, but not limited to, life-like flesh tones.

One advantage of the present invention is the cost savings concomitant with using a single print pass to create a printed item useful as both a primary display and heat transfer medium.

Other features and advantages of the present invention will be apparent from the following more detailed description of the preferred embodiments, taken in conjunction with the accompanying drawings which illustrate, by way of example, the principles of the invention.

### DETAILED DESCRIPTION OF THE INVENTION

The offset lithographic ink system of the present invention comprises a first colorant which is a conventional colorant, for example a dye or a pigment, which prints readily on the first substrate and does not transfer to the second substrate upon application of elevated temperature and pressure. The second colorant is a sublimation colorant. The sublimation colorant, for example, a dye or a pigment, may be any dye or colorant that is activated, or caused to diffuse or sublimate, at an elevated temperature, in excess of the operational temperature of the print engine, generally of at least about 350 degree F. For purposes of this application, use of the term “sublimation” or “heat activated” dye or colorant shall refer to all such colorants.

The remaining offset lithographic ink components may include dispersing agents, solvents, biocides, surfactants, and other such components generally known in the art of offset lithographic inks. The ink may contain one or more of any one of these known additive components.

The first substrate may comprise any material that can be printed upon by the offset lithographic printing process. It is preferable that the sublimation dye component not have a particular affinity for the first substrate. Generally, the first substrate is, for example, a type of paper, but any material suited to the purpose may be used.

The second substrate may be any type of material upon which it is desirable to affix a permanent image. Common second substrates include, for example, fabric, such as T-shirts, jackets, sweatshirts, shorts, pants, and hats; ceramics, such as coffee mugs, glasses, and plates; and office items, for example, mouse pads, plaques, and recognition and achievement items. The second substrate may also be, for example, metal, wood, or any other substrate that will accept and retain the sublimation colorant, whether alone or with the aid of a binding compound or other material that adheres to the second substrate and accepts the sublimation dyes.

The offset lithographic inks of the present invention are preferably formulated, for example, in the form of a paste. The ink may further include an agent or agents that aid in maintaining the first and second colorants in suspension within the ink over extended periods of time. Lithographic offset ink compositions are often stored prior to being loaded into the offset lithographic press. During this storage time, it is necessary that the colorants included in the ink are maintained in solution or suspension. Depending on the colorants used, there may further be a need for a dispersing agent. Some colorants that can be used in this type of ink are not readily soluble in the solvent and therefore require the assistance of a dispersing agent to maintain the colorant in homogeneous mixture with the remaining ink components.

The colorants suited for use in the inks include at least two different types of colorants. The first type of colorant is a conventional colorant. This colorant may be any pigment that does not require the application of elevated temperatures and/or pressure to activate, diffuse or liquefy the colorant. This first colorant transfers to the first substrate and is bound to the first substrate during the offset lithographic printing process. Suitable conventional colorants include, for example, any pigment which meets the above criteria with regard to activation, well known in the offset lithographic printing process.

The second type of colorant for use in ink of the present invention is a colorant commonly known and referred to in the art as a heat activated or sublimation colorant. This colorant is activated or sublimated at a temperature in excess of about 350 degree F., which is generally above the operation temperature of the offset lithographic printing press used to generate the first printed substrate. This type of colorant is known to be well suited for use in creating transfer mediums. The sublimation colorant is printed onto the first substrate, but is not activated or sublimated. Upon the subsequent application of heat and contact pressure the sublimation-type colorant is activated or sublimated, and transfers from the first substrate to the second substrate. After transfer, the sublimated colorant is bound to the second substrate.

The inks may further comprise a solvent system, which may be selected from one or more of those solvents known in the art for use in formulating offset lithographic inks, for example, McGee solvents. Other additives may also be included in the ink formulation. Such additives may include but are not limited to mineral seal oils, linseed oil, manganese dryers, surfactants, biocides, anti-oxidants, and others. These components are generally known in the art and may be included in the formulation by any known process for the addition of such components.

In formulating the inks, it may be advantageous to first prepare a dispersion of each coloring material and the solvent. Each colorant may first be homogeneously dispersed in a solvent. Additionally, varnishes may be used to embellish the rheology of the ink. These components are generally known in the art and may be included in the formulation by any known process for the addition of such components.

To achieve the offset lithographic ink system of the present invention, a known sublimation ink formulation suitable for use in an offset lithographic press, whether originally prepared or commercially purchased, is combined with a known conventional ink formulation suitable for use in an offset lithographic press, whether originally prepared or commercially purchased, by any known process for the addition of such components. Commercially available conventional offset lithographic inks that may suitably be used include, for example, inks such as Sun/Hartman commercial process inks, Kohl & Madden Xtreme set inks, Kemset inks, 725xb series inks, Flint inks, and Ecolith environmentally friendly inks. Commercially available conventional sublimation lithographic inks that may suitably be used include, for example, inks manufactured by Coates Screen, St. Charles, Ill.; Gans Ink & Supply Co., Marietta, Ga.; and Superior Printing Ink Co. Inc., New York, N.Y.

The offset lithographic printing process utilizes four separate base ink formulations to achieve desired final color characteristics. As the first substrate passes through the press, yellow, magenta, cyan and black inks are individually applied according to predetermined, computer controlled specifications. The overprinting of two or more base colors according to the predetermined, computer controlled specifications produces the final desired color characteristics.

The present invention uses a combined conventional and sublimation lithographic offset ink wherein the conventional ink/sublimation ink ratio of each of the magenta, cyan and black base ink formulations are substantially identical and the conventional ink/sublimation ink ratio of the yellow base ink formulation is greater than the conventional ink/sublimation ink ratio of the magenta, cyan and black base ink formulations.

The magenta, cyan, and black base ink formulation of the present invention contain from about 30% to about 70% of sublimation ink. Preferably, the magenta, cyan and black inks contain from about 45% to about 55% of sublimation ink, and most preferably, about 50%. Yellow base ink formulation of the present invention contains from about 5% to about 35% of sublimation ink, preferably, from about 15% to about 25% of sublimation ink, and most preferably, about 20%. The most preferable combination of conventional and sublimation offset lithographic inks used in the system of the present invention is a magenta, cyan and black base ink formulation each comprising about 50% conventional ink and about 50% sublimation ink and a yellow base ink formulation comprising about 80% conventional ink and about 20% sublimation ink.

The following test formulations were used to prepare an offset lithographic ink system in keeping with the foregoing disclosure.

### EXAMPLE 1

Conventional ink manufactured by Sun/Hartmann, Inc., and heat activated ink manufactured by Panel Print, Inc. of Old Forge, Pa. were combined in a conventional mixer then put through an ink mill to machine the ink into a creamy paste suitable for lithographic offset printing, formulated according to the following mixture ratios for each of yellow, magenta, cyan, and black inks:

30% Sun/Hartmann conventional

70% Panel Print sublimation

The resulting inks were run in a commercial lithographic offset sheet fed press at 4500 sheets per hour. Color characteristics of the first substrate were observed and found that the heat activated inks were too strong in color value.

The same procedure was repeated with mixture ratios for each of yellow, magenta, cyan, and black inks of:

### EXAMPLE 2

40% Sun/Hartmann conventional

60% Panel Print sublimation

### EXAMPLE 3

70% Sun/Hartmann conventional

30% Panel Print sublimation

### EXAMPLE 4

60% Sun/Hartmann conventional

40% Panel Print sublimation

### EXAMPLE 5

50% Sun/Hartmann conventional

50% Panel Print sublimation

All produced unsatisfactory first substrate color characteristics.

### EXAMPLE 6

Conventional ink manufactured by Sun/Hartmann, Inc., and heat activated ink manufactured by Panel Print, Inc. of Old Forge, Pa. were combined in a conventional mixer then put through an ink mill to machine the ink into a creamy paste suitable for lithographic offset printing, formulated according to the following ratios for each of yellow, magenta, cyan, and black inks:

Yellow: 80% Sun/Hartmann conventional
20% Panel Print sublimation

Magenta: 50% Sun/Hartmann conventional
50% Panel Print sublimation

Cyan: 50% Sun/Hartmann conventional
50% Panel Print sublimation

Black: 50% Sun/Hartmann conventional
50% Panel Print sublimation

The resulting inks were run in a commercial lithographic offset sheet fed press at 4500 sheets per hour. Color characteristics of both the first and second substrates were observed and found to provide commercially acceptable results, for example, commercially acceptable flesh tones.

Although the present invention has been described in connection with specific examples and embodiments, those skilled in the art will recognize that the present invention is capable of other variations and modifications within its scope. They are not intended to in any way limit the scope of the invention, and may be modified by the skilled artisan in keeping with known ink formulating techniques without deviating from the invention contemplated herein. These examples and embodiments are intended as typical of, rather than in any way limiting on, the scope of the present invention as presented in the appended claims.

What is claimed is:

1. A single pass offset lithographic ink system for use in preparing a first substrate having both commercially acceptable quality color characteristics and usable as a heat activated transfer medium to produce commercially acceptable quality color characteristics on a second substrate comprising a combination of a conventional offset lithographic ink and a sublimation offset lithographic ink wherein a conventional ink/sublimation ink ratio of each of a magenta, cyan and black base ink formulation are substantially identical and the conventional ink/sublimation ink ratio of a yellow base ink formulation is greater than the conventional ink/sublimation ink ratio of the magenta, cyan and black base ink formulations.

2. The system of claim 1 wherein the magenta, cyan, and black base ink formulation comprise from about 30% to about 70% sublimation ink.

3. The system of claim 1 wherein the magenta, cyan, and black base ink formulation comprise from about 45% to about 55% sublimation ink.

4. The system of claim 1 wherein the magenta, cyan, and black base ink formulation comprise about 50% sublimation ink.

5. The system of claim 1 wherein the yellow base ink formulation comprises from about 5% to about 35% sublimation ink.

6. The system of claim 1 wherein the yellow base ink formulation comprises from about 15% to about 25% sublimation ink.

7. The system of claim 1 wherein the yellow base ink formulation comprises about 20% sublimation ink.

8. The system of claim 1 wherein the magenta, cyan, and black base ink formulation comprise from about 30% to about 70% sublimation ink and the yellow base ink formulation comprises from about 5% to about 35% sublimation ink.

9. The system of claim 1 wherein the magenta, cyan, and black base ink formulation comprise from about 45% to about 55% sublimation ink and the yellow base ink formulation comprises from about 15% to about 25% sublimation ink.

10. A single pass offset lithographic ink system for use in preparing a first substrate having both commercially acceptable quality color characteristics and usable as a heat activated transfer medium to produce commercially acceptable quality color characteristics on a second substrate comprising a combination of a conventional offset lithographic ink and a sublimation offset lithographic ink wherein each of a magenta, cyan and black base ink formulation comprises about 50% sublimation ink and a yellow base ink formulation comprises about 20% sublimation ink.

11. The system of claim 10 wherein each of the magenta, cyan and black base ink formulation further comprises about 50% conventional ink and the yellow base ink formulation further comprises about 80% conventional ink.

12. A single pass offset lithographic ink system process for printing a first substrate having both commercially acceptable quality color characteristics and usable as a heat activated transfer medium to produce commercially acceptable quality color characteristics on a second substrate comprising the steps of:
a. combining a conventional offset lithographic ink and a sublimation offset lithographic ink wherein a conventional ink/sublimation ink ratio of each of a magenta, cyan and black base ink formulation are substantially identical and the conventional ink/sublimation ink ratio of a yellow base ink formulation is greater than the conventional ink/sublimation ink ratio of the magenta, cyan and black base ink formulations;
b. supplying the magenta, cyan, black and yellow base ink formulations to an offset lithographic press; and
c. operating the press to print a predetermined design of commercially acceptable quality on the first substrate.

13. The process of claim 12 wherein the magenta, cyan, and black base ink formulation comprise from about 30% to about 70% sublimation ink.

14. The process of claim 12 wherein the magenta, cyan, and black base ink formulation comprise from about 45% to about 55% sublimation ink.

15. The process of claim 12 wherein the magenta, cyan, and black base ink formulation comprise about 50% sublimation ink.

16. The process of claim 12 wherein the yellow base ink formulation comprises from about 5% to about 35% sublimation ink.

17. The process of claim 12 wherein the yellow base ink formulation comprises from about 15% to about 25% sublimation ink.

18. The process of claim 12 wherein the yellow base ink formulation comprises about 20% sublimation ink.

19. The process of claim 12 wherein the magenta, cyan, and black base ink formulation comprise from about 30% to about 70% sublimation ink and the yellow base ink formulation comprises from about 5% to about 35% sublimation ink.

20. The process of claim 12 wherein the magenta, cyan, and black base ink formulation comprise from about 45% to about 55% sublimation ink and the yellow base ink formulation comprises from about 15% to about 25% sublimation ink.

21. The process of claim 12 wherein each of a magenta, cyan and black base ink formulation comprises about 50% sublimation ink and a yellow base ink formulation comprises about 20% sublimation ink.

22. The process of claim 21 wherein each of the magenta, cyan and black base ink formulation further comprises about 50% conventional ink and the yellow base ink formulation further comprises about 80% conventional ink.
